(19) United States
(12) Patent Application Publication
(10) Pub. No.: US 2009/0284698 A1
(43) Pub. Date: Nov. 19, 2009

(54) Ink composition, color filter manufactured by using the same, and display device comprising the same

(76) Inventors: Mi-Kyoung Kim, Metropolitan City (KR); Dae-Hyun Kim, Metropolitan City (KR); Hyun-Sik Kim, Metropolitan City (KR); Duk-Sik Ha, Metropolitan City (KR); Dong-Chang Choi, Metropolitan City (KR); Han-Soo Kim, Metropolitan City (KR); Min-A Yu, Metropolitan City (KR)

Correspondence Address: MCKENNA LONG & ALDRIDGE LLP, 1900 K STREET, NW, WASHINGTON, DC, 20006, US

(21) Appl. No.: 12/453,563

(22) Filed: May 14, 2009

(30) Foreign Application Priority Data
May 16, 2008 (KR) 2008-0045723

(51) Int. Cl. G02F 1/1335; C08L 33/10; C08F 2/46; B05D 5/12

(52) U.S. Cl. 349/106; 524/558; 522/33; 522/63; 522/65; 427/67

(57) ABSTRACT

The present invention relates to an ink composition, and more particularly, to an ink composition that comprises a) a binder polymer; b) a polymerizable compound that has an ethylenical unsaturation bond; c) a thermal initiator or photo-initiator; d) I) a solvent that has a boiling point of 180° C. or more, II) a solvent that has a hydroxyl group, and III) a solvent that has a boiling point of less than 180° C.; and e) a pigment, a color filter that is manufactured by using the same, and a display device that includes the same.

When the ink composition according to the present invention is used in an inkjet method, it is possible to improve a contrast ratio according to excellent dispersion of fine pigment and improve an initial jetting property by using reduction of volatility.

### BACKGROUND OF THE INVENTION

1. Field of the Invention

The present invention relates to an ink composition that improves a contrast ratio according to dispersion of fine pigment and improves an initial jetting property by using reduction of volatility, a color filter that is manufactured by using the same, and a display device that comprises the same.

This application claims priority from Korean Patent Application No. 10-2008-0045723 filed on May 16, 2008 in the Korean Intellectual Property Office, the disclosure of which is incorporated herein by reference in its entirety.

2. Description of the Related Art

A general liquid crystal display is a device in which light passing from a backlight through a lower polarizing plate to be polarized, the permeability is controlled by liquid crystal while the polarizied light passes through a liquid crystal layer, a color filter layer, and an upper polarizing plate, such that an image is implemented. In order to obtain a good image in a liquid crystal display, it is important not to deteriorate polarizing properties of the polarized light in the polarizing plate. In particular, in the case of when the size of the pigment particle contained in the color filter layer is large, since the polarized light is subjected to depolarization because of the multiple scattering, contrast of the liquid crystal display is deteriorated. Accordingly, it is necessary to reduce the size of the pigment particle used to manufacture the color filter in order to implement the high quality of image. However, if the size of the pigment is reduced, since the surface area thereof is increased, it is difficult to disperse it.

In the art, generally, solvents such as PGMEA (propylene glycol methyl ether acetate), EEP (ethyl ethoxy propionate), MPA (methoxy propanol), BPA (butoxy propanol) are mostly used to disperse the fine pigment. However, since the solvent has the low boiling point of 180° C. or less and the volatility is comparatively large, in the case of when it is directly used in the inkjet process, there is a problem in that the initial jetting property is deteriorated.

The initial jetting property means a jetting property (or discharging property) of ink when ink is jetted after an inkjet head is stopped for a few second to a few minute. That is, the excellent initial jetting property means that ink is stably discharged without unstable position, unstable discharging, and non-discharging of ink drop even though the head is stopped for a few second to a few minute. When the color filter is manufactured by using an inkjet process, jetting may be performed after the head is stopped for a few second to a few minute because of exchanging of a glass substrate or alignment. At this time, if the initial jetting property is unstable, ink is not filled in a front pixel or ink is given to an undesired position to cause color mixing. In order to prevent this phenomenon, ink that has the stable initial jetting property should be used.

The initial jetting property problem is a phenomenon that is generated by the high volatility of ink. If jetting (or discharging) of the ink is stopped, the solvent component of ink is volatilized at an end of a nozzle, such that the viscosity is locally increased. If the jetting is carried out under the same condition as a known condition, ink is not discharged in a few mm region or a problem of unstable discharging position occurs. However, this phenomenon is removed if the discharging time is continuously maintained. In order to prevent this phenomenon, the volatility of ink should be reduced.

Japanese Unexamined Patent Application Publication No. 11-202114 discloses an ink for color filter which includes one or more selected from glycerin, diethyleneglycol or ethylene glycol used as a wetting agent in order to reduce the volatility. However, in the case of when the wetting agent is used, there is a problem in that it is difficult to obtain perfect drying, and the use of the wetting agent is limited because of the dispersion stability problem of the pigment.

### SUMMARY OF THE INVENTION

Therefore, it is an object of the present invention to provide an ink composition that improves a contrast ratio according to excellent dispersion of fine pigment and improves an initial jetting property by using reduction of volatility, a color filter that is manufactured by using the same, and a display device that comprises the same.

The present invention provides an ink composition that comprises a) a binder polymer; b) a polymerizable compound that has an ethylenical unsaturation bond; c) a thermal initiator or photo-initiator; d) I) a solvent that has a boiling point of 180° C. or more, II) a solvent that has a hydroxyl group, and III) a solvent that has a boiling point of less than 180° C.; and e) a pigment.

In addition, the present invention provides a color filter that comprises a light blocking portion that is formed by a black matrix pattern; and a pixel portion that is filled with an ink layer formed by using the ink composition.

In addition, the present invention provides a display device that comprises the color filter.

The ink composition according to the present invention can improve a contrast ratio according to excellent dispersion of fine pigment and improve an initial jetting property by using reduction of volatility.

### DESCRIPTION OF THE PREFERRED EMBODIMENTS

The ink composition according to the present invention is characterized in that the ink composition comprises a) a binder polymer; b) a polymerizable compound that has an ethylenical unsaturation bond; c) a thermal initiator or photo-initiator; d) I) a solvent that has a boiling point of 180° C. or more, II) a solvent that has a hydroxyl group, and III) a solvent that has a boiling point of less than 180° C.; and e) a pigment.

As a) the binder polymer, the binder is not particularly limited as long as it can act as a binder, and a homopolymer of monomers that are known in the art or a copolymer that is manufactured by copolymerizing two kinds or more monomers may be used.

Non-limiting examples of the monomer may include styrene, chloro styrene, α-methyl styrene, vinyltoluene, 2-ethylhexyl(meth)acrylate, methyl(meth)acrylate, ethyl(meth)acrylate, butyl(meth)acrylate, benzyl(meth)acrylate, glycidyl(meth)acrylate, dimethylaminoethyl(meth)acrylate, isobutyl(meth)acrylate, t-butyl(meth)acrylate, cyclohexyl(meth)acrylate, dicyclopentanyl(meth)acrylate, isobonyl(meth)acrylate, 2-phenoxyethyl(meth)acrylate, tetrahydroperfuryl(meth)acrylate, hydroxyethyl(meth)acrylate, 2-hydroxyethyl(meth)acrylate, 2-hydroxypropyl(meth)acrylate, 2-hydroxy-3-chloropropyl(meth)acrylate, 2-hydroxybutyl(meth)acrylate, 4-hydroxybutyl(meth)acrylate, dimethylaminomethyl(meth)acrylate, diethylamino(meth)acrylate, acyloctyloxy-2-hydroxypropyl(meth)acrylate, ethylhexyl acrylate, 2-methoxyethyl(meth)acrylate, 3-methoxybutyl(meth)acrylate, butoxyethyl(meth)acrylate, ethoxydiethyleneglycol(meth)acrylate, methoxytriethyleneglycol(meth)acrylate, methoxytripropyleneglycol(meth)acrylate, methoxypolyethyleneglycol(meth)acrylate, phenoxydiethyleneglycol(meth)acrylate, p-nonylphenoxypolyethyleneglycol(meth)acrylate, p-nonylphenoxypolypropyleneglycol(meth)acrylate, tetrafluoropropyl(meth)acrylate, 1,1,1,3,3,3-hexafluoroisopropyl(meth)acrylate, octafluoropentyl(meth)acrylate, heptadecafluorodecyl(meth)acrylate, tribromophenyl(meth)acrylate, methyl α-hydroxymethyl acrylate, ethyl α-hydroxymethyl acrylate, propyl α-hydroxymethyl acrylate, butyl α-hydroxymethyl acrylate, N-phenylmaleimide, N-(4-chlorophenyl)maleimide, methacrylic acid, maleic acid, itaconic acid or a mixture thereof, but are not limited thereto.

It is preferable that the weight average molecular weight of a) the binder polymer is in the range of 1,000 to 50,000. In the case of when the weight average molecular weight is less than 1,000, the strength of the manufactured color filter ink film may be reduced, and in the case of when the weight average molecular weight is more than 50,000, since the viscosity of ink is increased, a jetting property may become poor or cannot be obtained.

It is preferable that the content of a) the binder polymer is in the range of 1 to 20 wt % on the basis of the total weight of the ink composition. In the case of when the content of the binder polymer is less than 1 wt %, it is impossible to obtain a desired film strength and chemical resistance may be largely deteriorated, and in the case of when the content of the binder polymer is more than 20 wt %, since the viscosity of the ink composition is increased, a jetting property is largely deteriorated and it is impossible to obtain a desired color.

As b) the polymerizable compound that has the ethylenical unsaturation bond, a compound that has at least one addition-polymerizable unsaturation group in a molecule may be used.

Non-limiting examples of b) the polymerizable compound that has the ethylenical unsaturation bond may be one or more selected from the group consisting of ethyleneglycol diacrylate, triethyleneglycol diacrylate, 1,3-butanediol diacrylate, neopentylglycol diacrylate, 1,6-hexanediol diacrylate, trimethylol triacrylate, trimethylolpropane triacrylate, pentaerithrytol triacrylate, ditrimethylolpropane tetraacrylate, dipentaerithrytol tetraacrylate, dipentaerithrytol pentaacrylate, dipentaerithrytol hexaacrylate, and a(meth)acrylate monomer thereof, but are not limited thereto.

It is preferable that the amount of b) the polymerizable compound that has the ethylenical unsaturation bond is in the range of 1 to 20 wt % on the basis of the total weight of the ink composition. In the case of when the content of the polymerizable compound that has the ethylenical unsaturation bond is less than 1 wt %, chemical resistance and the film strength may be deteriorated by unsufficient crosslinking density. In the case of when the content of the polymerizable compound is more than 20 wt %, the amount of the other ink composition is reduced, such that properties such as a color, spreadability, and adhesion property of the color filter film may be deteriorated.

As detailed examples of c) the thermal initiator, one or more that are selected from the group consisting of 2,2′-azobisisobutyronitrile (AIBN), 2,2′-azobis-(2,4-dimethylvaleronitrile), 2,2′-azobis-(4-methoxy-2,4-dimethylvaleronitrile), 2-cyano-2-propylazoformamide, 1,1′-azobis(cyclohexane-1-carbonitrile), 2,2′-azobis(2-methylbutyronitrile), V-40, VA-086, VA-085, VF096, and Vam-110, Vam-111 (manufactured by Wako pure chemicals ind.), benzoylperoxide, lauroylperoxide, t-butylperoxypivalate and 1,1′-bis-(bis-t-butylperoxy)cyclohexane may be used, but the examples thereof are not limited thereto.

In addition, as detailed examples of c) photo-initiator, one or more selected from the group consisting of an acetophenone-based compound such as 2-hydroxy-2-methyl-1-phenylpropane-1-on, 1-(4-isopropylphenyl)-2-hydroxy-2-methylpropane-1-on, 4-(2-hydroxyethoxy)-phenyl-(2-hydroxy-2-propyl)ketone, 1-hydroxycyclohexylphenylketone, benzoinemethyl ether, benzoineethyl ether, benzoineisobutyl ether, benzoinebutyl ether, 2,2-dimethoxy-2-phenylacetophenone, 2-methyl-(4-methylthio)phenyl-2-morpholino-1-propane-1-on, 2-benzyl-2-dimethylamino-1-(4-morpholinophenyl)-butane-1-on, or 2-methyl-1-[4-(methylthio)phenyl]-2-morpholinopropane-1-on; a biimidazole-based compound such as 2,2-bis(2-chlorophenyl)-4,4′,5,5′-tetraphenyl biimidazole, 2,2′-bis(o-chlorophenyl)-4,4′,5,5′-tetrakis(3,4,5-trimethoxyphenyl)-1,2′-biimidazole, 2,2′-bis(2,3-dichlorophenyl)-4,4,5,5′-tetraphenyl biimidazole, or 2,2′-bis(o-chlorophenyl)-4,4,5,5′-tetraphenyl-1,2′-biimidazole; a triazine-based compound such as 3-{4-[2,4-bis(trichloromethyl)-s-triazine-6-yl]phenylthio}propionic acid, 1,1,1,3,3,3-hexafluoroisopropyl-3-{4-[2,4-bis(trichloromethyl)-s-triazine-6-yl]phenylthio}propionate, ethyl-2-{4-[2,4-bis(trichloromethyl)-s-triazine-6-yl]phenylthio}acetate, 2-epoxyethyl-2-{4-[2,4-bis(trichloromethyl)-s-triazine-6-yl]phenylthio}acetate, cyclohexyl-2-{4-[2,4-bis(trichloromethyl)-s-triazine-6-yl]phenylthio}acetate, benzyl2-{4-[2,4-bis(trichloromethyl)-s-triazine-6-yl]phenylthio}acetate, 3-{chloro-4-[2,4-bis(trichloromethyl)-s-triazine-6-yl]phenylthio}propionic acid, 3-{4-[2,4-bis(trichloromethyl)-s-triazine-6-yl]phenylthio}propionamide, 2,4-bis(trichloromethyl)-6-p-methoxystyryl-s-triazine, 2,4-bis(trichloromethyl)-6-(1-p-dimethylaminophenyl)-1,3,-butadienyl-s-triazine, or 2-trichloromethyl-4-amino-6-p-methoxystyryl-s-triazine; and an oxime-based compound such as CGI-242 and CGI-124 manufactured by Chiba, Co., Ltd. in Japan may be used, but the examples thereof are not limited thereto.

It is preferable that the content of c) the thermal initiator or photo-initiator is in the range of 0.1 to 5 wt % on the basis of the total weight of the ink composition. In the case of when the content of the thermal initiator or photo-initiator is less than 0.1 wt %, since the sufficient radical is not generated, the degree of curing of the color ink film may be deteriorated, such that the film strength and chemical resistance may be deteriorated. In addition, in the case of when the content of the thermal initiator or photo-initiator is more than 5 wt %, the viscosity may be increased and fume may be generated because of an excessive amount of initiator.

In the present invention, as the solvent, d) I) the solvent that has the boiling point of 180° C. or more, II) the solvent that has the hydroxyl group and III) the solvent that has the boiling point of less than 180° C. may be used, such that the contrast ratio according to the dispersion of fine pigment is improved and the initial jetting property is improved by reduction of volatility when it is applied to an inkjet method.

I) the solvent that has the boiling point of 180° C. or more is a main solvent, and functions to prevent drying of an end of a nozzle such that ink jetting (discharging) is well carried out. As I) the solvent that has the boiling point of 180° C. or more, it is preferable to use the solvent that does not have the hydroxyl group, has a boiling point in the range of 180 to 300° C., and a vapor pressure of 0.5 mmHg or lower at normal temperature. As non-limiting examples thereof, one or more selected from the group consisting of ethylene glycol monobutyl ether acetate, diethylene glycol monobutyl ether acetate, diethylene glycol monoethyl ether acetate, dipropylene glycol monomethyl ether acetate, dipropylene glycol ethyl ether acetate, dipropylene glycol propyl ether acetate, and dipropylene glycol monobutyl ether acetate may be used, but the examples thereof are not limited thereto.

It is preferable that I) the solvent that has the boiling point of 180° C. or more is included in an amount in the range of 50 to 95 wt % on the basis of the total weight of the solvent. In the case of when the content of the solvent that has the boiling point of 180° C. or more is less than 50 wt %, since the volatility of the ink is large, there is a problem in terms of jetting property (discharging property). In the case of when the content of the solvent is more than 95 wt %, since the viscosity is increased, the jetting property is deteriorated. Since the dispersibility of the pigment is poor, stability and contrast of the ink may be deteriorated.

II) the solvent that has the hydroxyl group functions to reduce the volatility of III) the solvent that has the boiling point of less than 180° C., and regardless of the boiling point of the solvent, it can be used without a limitation as long as it is the solvent that has the hydroxyl group. As non-limiting examples thereof, alcohols, phenols, glycol ethers may be used, and glycol ethers are more preferable. As detailed examples thereof, one or more selected from the group consisting of alcohols such as ethanol, propanol, butanol, methoxy propanol, ethoxy propanol, butoxy propanol, i-propyl alcohol, and benzyl alcohol; phenols such as phenol, 2-propyl phenol, 2-isopropyl phenol, 2-sec-butyl phenol, 2-tert-butyl phenol, 2-phenylphenol, 2-cyclohexyl phenol, 2-nonylphenol, 2-naphthyl phenol, 4-propyl phenol, 4-cyclohexyl phenol, 4-naphthyl phenol, 4-dodecyl phenol, and 4-octadecyl phenol; and glycol ethers such as ethylene glycol monophenyl ether, ethylene glycol monohexyl ether, ethylene glycol 2-ethylhexyl ether, diethylene glycol monomethyl ether, diethylene glycol monoethyl ether, diethylene glycol monopropyl ether, diethylene glycol monobutyl ether, diethylene glycol monohexyl ether, triethylene glycol monomethyl ether, triethylene glycol monoethyl ether, triethylene glycol monobutyl ether, triethylene glycol monopropyl ether, dipropylene glycol monobutyl ether, tripropylene glycol monomethyl ether, and tripropylene glycol monobutyl ether, but the examples thereof are not limited thereto.

It is preferable that II) the solvent that has the hydroxyl group is included in an amount in the range of 5 to 50 wt % on the basis of the total weight of the solvent, and the content thereof is higher than that of III) the solvent that has the boiling point of less than 180° C. In the case of when the content of the solvent that has the hydroxyl group is less than 5 wt %, a volatility deterioration effect may not be shown, and in the case of when the content of the solvent is more than 50 wt %, because of the high viscosity of ink, jetting may be difficult to perform. In addition, in the case of when the solvent that has the hydroxyl group is included in the content that is lower than that of III) the solvent that has the boiling point of less than 180° C., a volatility reduction effect by the solvent that has the hydroxyl group may not be sufficiently obtained, and when the ink is discharged for a long period of time, the jetting stability may be deteriorated.

III) the solvent that has the boiling point of less than 180° C. functions to facilitate the dispersion of fine pigment components and appropriately reduce the viscosity of ink, and is preferably a solvent that has the boiling point of 50° C. or more and less than 180° C. As non-limiting examples thereof, one or more selected from the group consisting of propylene glycol methyl ether acetate, ethylene glycol monomethyl ether acetate, ethylene glycol ethyl ether acetate, propylene glycol monobutyl ether acetate, ethyl iso-butyl ether, ethyl ethoxy propionate, methoxy propanol, butoxy propanol, 2-butoxy ethanol, butyl acetate, 1-butoxy-2-propanol, cyclohexanone, dimethyl ketone, methyl butyl ketone and methyl hexyl ketone may be used, but the examples thereof are not limited thereto.

It is preferable that III) the solvent that has the boiling point of less than 180° C. is included in an amount in the range of 0.01 to 30 wt % on the basis of the total weight of the solvent. In the case of when the content of the solvent that has the boiling point of less than 180° C. is less than 0.01 wt %, the fine pigment may not be stably dispersed, and in the case of when the content of the solvent is more than 30 wt %, since the volatility of ink is increased, the initial jetting property may be deteriorated.

It is preferable that the solvent that includes all components I), II), and III) is included in an amount in the range of 65 to 85 wt % on the basis of the total weight of the ink composition. In the case of when the content of the solvent is less than 65 wt %, the viscosity of ink may be increased, and in the case of when the content of the solvent is more than 85 wt %, since the content of solid of ink is reduced, the number of ink drops which will be filled in pixels may be increased in order to ensure the same thickness.

As e) the pigment, a general pigment may be used as long as it does not negatively affect the dispersion, and it is preferable to use the pigment including finely processed particles. It is preferable that the particle size of the pigment particles is mainly 0.3 μm or less, and it is more preferable that 90% or more pigment particles having the particle size of 0.2 μm or less are distributed. In the case of when the size of the pigment is more than 0.3 μm, since permeation of light is not smooth, the permeability of the manufactured color filter may become poor and it is impossible to obtain the high contrast ratio.

As the red pigment that is used in order to show a color property in the ink composition according to the present invention, Pig.Red #1, Pig.Red #2, Pig.Red #3, Pig.Red #4, Pig.Red #5, Pig.Red #6, Pig.Red #7, Pig.Red #8, Pig.Red #9, Pig.Red #10, Pig.Red #11, Pig.Red #12, Pig.Red #13, Pig.Red #14, Pig.Red #15, Pig.Red #16, Pig.Red #17, Pig.Red #18, Pig.Red #21, Pig.Red #22, Pig.Red #23, Pig.Red #31, Pig.Red #32, Pig.Red #95, Pig.Red #112, Pig.Red #114, Pig.Red #119, Pig.Red #146, Pig.Red #147, Pig.Red #148, Pig.Red #150, Pig.Red #151, Pig.Red #184, Pig.Red #187, Pig.Red #188, Pig.Red #210, Pig.Red #245, Pig.Red #253, Pig.Red #258, and Pig.Red #261 which are the naphthol-based red pigment; Pig.Red #49, Pig.Red #49:1, Pig.Red #49:2, Pig.Red #49:3, Pig.Red #50:1, Pig.Red #51:1, Pig.Red #53, Pig.Red #53:1, Pig.Red #68, Pig.Red #243, and Pig.Red #247 which are a metal complex with naphthols; Pig.Red #37, Pig.Red #38, and Pig.Red #41 which are disazopyrazolones; Pig.Red #144, Pig.Red #166, Pig.Red #220, Pig.Red #221, and Pig.Red #242 which are a disazo-based condensate; Pig.Red #48:1, Pig.Red #48:2, Pig.Red #48:3, Pig.Red #48:4, Pig.Red #48:5, Pig.Red #52:1, Pig.Red #52:2, Pig.Red #57:1, Pig.Red #58:2, Pig.Red #58:4, Pig.Red #63:1, Pig.Red #63:2, Pig.Red #64, Pig.Red #64:1, and Pig.Red #200 which are a 2-hydroxy-3-naphthoic acid based metal complex; Pig.Red #60:1, Pig.Red #66, and Pig.Red #67 which are a naphthalene sulfonic acid metal complex; Pig.Red #81:1, Pig.Red #81:3, and Pig.Red #169 which are triarylcarboniums; Pig.Red #89, and Pig.Red #177 which are anthraquinones; Pig.Red #88, and Pig.Red #181 which are thioindigos; Pig.Red #122, Pig.Red #207, and Pig.Red #209 which are quinacrydones; Pig.Red #123, Pig.Red #149, Pig.Red #178, Pig.Red #179, Pig.Red #190, Pig.Red #194, and Pig.Red #224 which are perylenes; Pig.Red #171, Pig.Red #175, Pig.Red #176, Pig.Red #185, and Pig.Red #208 which are benzimidazolones; Pig.Red #216 which are pyranthrones; Pig.Red #254 which is diketopyrrolopyrroles; and Pig.Red #260 which is isoindolines may be used.

As the violet pigment, Pig.Violet#1, Pig.Violet#2, Pig.Violet#3, Pig.Violet#27, and Pig.Violet#39 which are triarylcarboniums; Pig.Violet#5:1 which is anthraquinones; Pig.Violet#25, and Pig.Violet#50 which are naphthols; Pig.Violet#19 which is quinacrydones; Pig.Violet#23, and Pig.Violet#37 which are dioxazines; Pig.Violet#29 which is perylenes; and Pig.Violet#32 which is benzimidazolones may be used.

As the blue pigment, Pig.Blue#1, Pig.Blue#2, Pig.Blue#9, Pig.Blue#10, Pig.Blue#14, Pig.Blue#18, Pig.Blue#19, Pig.Blue#56, and Pig.Blue#62 which are triarylcarboniums; Pig.Blue#15, Pig.Blue#15:1, Pig.Blue#15:3, Pig.Blue#15:4, and Pig.Blue#15:6 which are Cu phthalocyanines; Pig.Blue#16 which is metal-free phthalocyanines; Pig.Blue#60, and Pig.Blue#64 which are indanthrones; and Pig.Blue#66, and Pig.Blue#63 which are indigos may be used.

As the green pigment, Pig.Green#1, Pig.Green#2, and Pig.Green#4 which are triarylcarboniums; Pig.Green#7, and Pig.Green#36 which are Cu phthalocyanines; and Pig.Green#8, and Pig.Green#10 which are a metal complex may be used.

As the yellow pigment, Pig.Yellow#1, Pig.Yellow#2, Pig.Yellow#3, Pig.Yellow#5, Pig.Yellow#6, Pig.Yellow#10, Pig.Yellow#49, Pig.Yellow#65, Pig.Yellow#73, Pig.Yellow#74, Pig.Yellow#75, Pig.Yellow#97, Pig.Yellow#98, Pig.Yellow#111, Pig.Yellow#116, and Pig.Yellow#167 which are monoazos; Pig.Yellow#61, Pig.Yellow#62:1, Pig.Yellow#100, Pig.Yellow#168, Pig.Yellow#169, and Pig.Yellow#183 which are a monoazo-based metal complex; Pig.Yellow#16 which is bisacetoacetarylrides; Pig.Yellow#12, Pig.Yellow#13, Pig.Yellow#14, Pig.Yellow#17, Pig.Yellow#55, Pig.Yellow#63, Pig.Yellow#81, Pig.Yellow#83, Pig.Yellow#87, Pig.Yellow#113, Pig.Yellow#114, Pig.Yellow#124, Pig.Yellow#126, Pig.Yellow#127, Pig.Yellow#152, Pig.Yellow#170, Pig.Yellow#171, Pig.Yellow#172, and Pig.Yellow#174 which are diarylrides; Pig.Yellow#24 which is flavanthrones; Pig.Yellow#93, Pig.Yellow#94, Pig.Yellow#95, Pig.Yellow#128, and Pig.Yellow#166 which are a diazo-based condensate; Pig.Yellow#123, and Pig.Yellow#147 which are anthraquinones; Pig.Yellow#101 which is aldazines; Pig.Yellow#104 which is a naphthalene sulfonic acid metal complex; Pig.Yellow#108 which is anthrapyrimidines; Pig.Yellow#109, Pig.Yellow#110, Pig.Yellow#139, and Pig.Yellow#185 which are isoindolinones; Pig.Yellow#123, Pig.Yellow#154, Pig.Yellow#175, Pig.Yellow#180, and Pig.Yellow#181 which are benzimidazolones; Pig.Yellow#138 which is quinophthalones; Pig.Yellow#117, Pig.Yellow#129, Pig.Yellow#150, Pig.Yellow#153, Pig.Yellow#177, and Pig.Yellow#179 which are a metal complex may be used.

In addition to this, as the orange pigment, Pig.Orange#1, and Pig.Orange#6 which are monoazos; Pig.Orange#2, Pig.Orange#5, Pig.Orange#22, Pig.orange#24, and Pig.Orange#38 which are naphthols; Pig.Orange#17, Pig.Orange#17:1, and Pig.Orange#46 which are a naphthol metal complex; Pig.Orange#13, and Pig.Orange#34 which are disazopyrazolones; Pig.Orange#15, and Pig.Orange#16 which are diarylrides; Pig.Orange#19 which is a naphthalene sulfonic acid metal complex; Pig.orange#31 which is a disazo-based condensate; Pig.Orange#36, and Pig.Orange#60 which are benzimidazolones; Pig.Orange#40 which is pyranthrones; Pig.Orange#43 which is perynones; Pig.orange#48 which is quinacrydones; and Pig.Orange#61, Pig.Orange#66 or Pig.Orange#69 which are isoindolines may be used.

In the ink composition, it is preferable that the pigment that is used to show the color property is added in an amount in the range of 5 to 30 wt % on the basis of the total weight of the ink composition according to the required color property. In the case of when the content of the coloring agent used in the ink composition is not appropriate, it is impossible to obtain a product having a required image quality while the color filter is manufactured.

The ink composition according to the present invention may further include a dispersing agent. It is preferable that the dispersing agent is used in order to uniformly disperse the pigment. As non-limiting examples of the dispersing agent, it is preferable that surfactants such as cations, anions, nonions, positive silicons, and fluorines are used or polymer surfactants (polymer dispersing agent) are used. For example, polyethylene imine, urethane resin, acryl resin, and polyester polymer dispersing agents may be used. It is preferable that the dispersing agent is added in an amount in the range of 2 to 15 wt % on the basis of the total weight of the ink composition.

The ink composition according to the present invention may further include, in addition to the dispersing agent, one or more additives that are selected from a curing accelerating agent, a thermal polymerization inhibiting agent, a plasticizer, an adhesion accelerating agent, a filler, a defoaming agent, a dispersion assisting agent, an agglomeration preventing agent, and a surfactant.

It is preferable that the additive is added in an amount in the range of 0.01 to 3 wt % on the basis of the total weight of the ink composition.

In addition, the present invention provides a color filter that comprises a light blocking portion that is formed by a black matrix pattern; and a pixel portion that is filled with an ink layer formed by using the ink composition.

The color filter may be manufactured by the steps of forming and curing a black matrix pattern using a method that is known in the art on the substrate to manufacture a light blocking portion that is formed by the black matrix pattern and a pixel portion that is divided by the black matrix pattern; filling the ink composition according to the present invention on the pixel portion formed by the black matrix pattern by using an inkjet method; and curing the filled ink composition.

The material of the substrate is not particularly limited, but a glass substrate, a plastic substrate, or other flexible substrates may be used. It is preferable that the transparent glass substrate having the strong heat resistance is used.

The inkjet method is a method in which ink droplets are discharged to the pixel portion divided by the black matrix pattern in a non-contact manner using an ink nozzle.

In the case of when the filled ink composition includes a thermal initiator, it is preferable that after pre-bake is performed at a temperature in the range of 50 to 120° C., post-bake is performed at a temperature in the range of 180 to 240° C. If the temperature of the heat curing is less than 180° C., since vaporization of the solvent and thermal curing are insufficient, the film strength and the chemical resistance may be deteriorated. If the temperature of the heat curing is more than 240° C., because of excessive volume shrinkage of the pixel portion, problems may occur in terms of an adhesion property to the substrate and the degree of precision, and the formed film may be damaged by heat.

In addition, it is preferable that the curing of the filled ink composition is performed, in the case of when a photo-initiator is used, in an exposure amount in the range of 40 to 300 mJ/cm². If the exposure amount is less than 40 mJ/cm², since the photocuring is insufficient, the film strength and the chemical resistance-may be deteriorated. If the exposure amount is more than 300 mJ/cm², since the time required to perform the exposure process is increased, a problem such as a tac time may occur. After the exposure process, it is preferable that the formed ink film is added to the oven at a temperature in the range of 180 to 230° C. and additionally cured.

In addition, the present invention provides a display device that comprises the color filter. The display device may be a liquid crystal display device. An example of the liquid crystal display device may include a liquid crystal display device in which a light source, a polarizing plate, a TFT-array substrate, a pixel electrode, a liquid crystal cell, a common electrode, a color filter and a polarizing plate are sequentially layered, but is not limited thereto.

A manufacturing method of a liquid crystal display device according to the present invention may adopt a technology that is known in the art, except that the ink composition according to the present invention is used.

Hereinbelow, the present invention will be described in detail with reference to Examples. The present invention may, however, be embodied in many different forms and should not be construed as being limited to the Examples set forth herein. Rather, these Examples are provided to fully convey the concept of the invention to those skilled in the art.

### SYNTHETIC EXAMPLE

### Manufacturing of the Acryl Copolymer

After 1.6 parts by weight of V65 was dissolved in the solvent in the reaction vessel as the thermal initiator, benzyl methacrylate/methacrylic acid were added thereto in a mole ratio of 68/32 and reacted with each other under nitrogen atmosphere at 65° C. for 7.5 hours. The obtained copolymer solution was added to the flask equipped with the agitator, glycidyl methacrylate was added thereto, and they were further reacted at 110° C. for 6 hours to obtain the acryl copolymer.

### EXAMPLE 1

On the basis of 100 parts by weight of the ink composition, 5.8 parts by weight of R254 that was the red pigment, 1.1 parts by weight of Y150, 4.3 parts by weight of the pigment dispersing agent, 3.4 parts by weight of the acryl copolymer manufactured in Synthetic Example, 6.9 parts by weight of dipentaerythritol hexaacrylate that was the polymerizable monomer, 0.5 parts by weight of V-40 (1,1′-Azobis(cyclohexane-1-carbonitrile) as the thermal initiator, 53.3 parts by weight of the diethylene glycol monobutyl ether acetate (BCA) as the solvent, 23.4 parts by weight of diethylene glycol monobutyl ether (BC), and 1.3 parts by weight of other solvents including propylene glycol methyl ether acetate (PGMEA) and butoxy propanol were mixed with each other for 3 hours to manufacture the red ink composition.

### EXAMPLES 2 TO 4 AND COMPARATIVE EXAMPLES 1 TO 6

The ink composition, which had the composition and the content described in the following Table 1 and Table 2 was manufactured by using the same method as Example 1.

TABLE 1

| | | Exam- | | | |
|---|---|---|---|---|---|
| | | ple 1 | Example 2 | Example 3 | Example 4 |
| Pigment | R254 | 5.8 | 5.8 | 5.5 | — |
| | Y150 | 1.1 | 1.1 | 1.4 | — |
| | B 15:6 | — | — | — | 5.5 |
| Dispersing | dispersing | 4.3 | 4.3 | 4.3 | 4.4 |
| agent | agent | | | | |
| Binder | acryl | 3.4 | 3.4 | 3.4 | 4.4 |
| | copolymer | | | | |
| Polymerizable | DPHA | 6.9 | 6.9 | 6.9 | 13.1 |
| monomer | | | | | |
| Thermal | V-40 | 0.5 | 0.5 | 0.5 | 0.5 |
| initiator | | | | | |
| Solvent | BCA | 53.3 | 53.3 | — | 47.9 |
| | ECA | — | — | 49.6 | — |
| | BC | 23.4 | — | 23.4 | 20.7 |
| | EC | — | 23.4 | — | — |
| | Other | 1.3 | 1.3 | 5.0 | 3.5 |
| | solvent | | | | |
| | including | | | | |
| | PGMEA | | | | |

TABLE 2

| | | Comparative | Comparative | Comparative | Comparative | Comparative | Comparative |
|---|---|---|---|---|---|---|---|
| | | Example 1 | Example 1 | Example 1 | Example 1 | Example 1 | Example 1 |
| Pigment | R254 | 5.6 | 5.6 | 5.8 | 5.5 | — | 5.6 |
| | Y150 | 0.9 | 0.9 | 1.1 | 1.4 | — | 0.9 |
| | B 15:6 | — | — | — | — | 5.5 | — |
| Dispersing | dispersing | 4.7 | 4.7 | 4.3 | 4.3 | 4.4 | 4.7 |
| agent | agent | | | | | | |
| Binder | acryl | 3.8 | 3.8 | 3.4 | 3.4 | 4.4 | 3.8 |
| | copolymer | | | | | | |
| Polymerizable | DPHA | 7.5 | 7.5 | 6.9 | 6.9 | 13.1 | 7.5 |
| monomer | | | | | | | |
| Thermal | V-40 | 0.5 | 0.5 | 0.5 | 0.5 | 0.5 | 0.5 |
| initiator | | | | | | | |
| Solvent | BCA | 58.6 | 77.0 | 76.7 | | 68.6 | 53.6 |
| | ECA | — | — | | 73.0 | | — |
| | BC | — | — | — | — | — | 23.4 |
| | EC | — | — | — | — | — | — |
| | Other | 18.4 | — | 1.3 | 5.0 | 3.5 | — |
| | solvent | | | | | | |
| | including | | | | | | |
| | PGMEA | | | | | | |

The ink composition manufactured in Comparative Example 2 and Comparative Example 6 showed the the high viscosity since the dispersion stability was poor. Accordingly, it could not be used as ink for inkjet.

### EXPERIMENTAL EXAMPLE

Contrast Ratio Property

The color filter, to the upper and the lower parts of which the polarizing plate was attached, was manufactured by using the ink composition manufactured in Example 1, Example 2 and Comparative Example 1. The brightness values were measured when vertical/horizontal states in respects to the lower polarizing plate by rotating the polarizing plate attached to the upper portion, and the contrast ratio is described in the following Table 3.

TABLE 3

| | Contrast ratio | | Contrast ratio |
|---|---|---|---|
| Example 1 | 2789 | Comparative | 2834 |
| | | Example 1 | |
| Example 2 | 2767 | | — |

As could be shown in Table 3, even though the ink composition according to the present invention has the low content of solvent having the low boiling point, the ink composition showed the same level of contrast ratio as the known technology.

Initial Jetting Property

Evaluation method of the initial jetting property After the ink composition manufactured in Example 1 to Example 4 and Comparative Example 1 to Comparative Example 6 was injected into the inkjet head, the same pattern was carried out twice so that the pitch between liquid drops was 40. At this time, the first pattern was subjected to purging and wiping, and jetted after the waiting time of 6 min. Next, the second pattern was jetted under the first pattern within about a few seconds. Since the second pattern had the waiting time that was short within a few seconds, it was normally discharged. Thus, on the basis of this, the region length in which the initial jetting was unstable was calculated, and the results are described in the following Table 4.

TABLE 4

| | Initial jetting | | Initial jetting |
|---|---|---|---|
| | property evaluation | | property evaluation |
| | result | | result |
| | (when jetting was | | (when jetting was |
| | performed after | | performed after pause |
| | pause for 6 min) | | for 6 min) |
| Example 1 | No unstable initial | Comparative | Occurrence of 10 mm or |
| | jetting region | Example 1 | more unstable initial |
| | | | jetting region |
| Example 2 | No unstable initial | Comparative | — |
| | jetting region | Example 2 | |
| Example 3 | No unstable initial | Comparative | Occurrence of 400 μm or |
| | jetting region | Example 3 | more unstable initial |
| | | | jetting region |
| Example 4 | No unstable initial | Comparative | Occurrence of 1000 μm |
| | jetting region | Example 4 | or more unstable |
| | | | initial jetting region |
| | | Comparative | Occurrence of 200 μm or |
| | | Example 5 | more unstable initial |
| | | | jetting region |
| | | Comparative | — |
| | | Example 6 | |

1. An ink composition comprising:
a) a binder polymer;
b) a polymerizable compound that has an ethylenical unsaturation bond;
c) a thermal initiator or photo-initiator;
d) I) a solvent that has a boiling point of 180° C. or more, II) a solvent that has a hydroxyl group, and III) a solvent that has a boiling point of less than 180° C.; and
e) a pigment.

2. The ink composition as set forth in claim 1, wherein) the binder polymer is manufactured by polymerizing one or more selected from the group consisting of styrene, chlorostyrene, α-methyl styrene, vinyl toluene, 2-ethylhexyl(meth)acrylate, methyl(meth)acrylate, ethyl(meth)acrylate, butyl(meth)acrylate, benzyl(meth)acrylate, glycidyl(meth)acrylate, dimethylaminoethyl(meth)acrylate, isobutyl(meth)acrylate, t-butyl(meth)acrylate, cyclohexyl(meth)acrylate, dicyclopentanyl(meth)acrylate, isobonyl(meth)acrylate, 2-phenoxyethyl(meth)acrylate, tetrahydroperfuryl(meth)acrylate, hydroxyethyl(meth)acrylate, 2-hydroxyethyl(meth)acrylate, 2-hydroxypropyl(meth)acrylate, 2-hydroxy-3-chloropropyl(meth)acrylate, 2-hydroxybutyl(meth)acrylate, 4-hydroxybutyl(meth)acrylate, dimethylaminomethyl(meth)acrylate, diethylamino(meth)acrylate, acyloctyloxy-2-hydroxypropyl(meth)acrylate, ethylhexyl acrylate, 2-methoxyethyl(meth)acrylate, 3-methoxybutyl(meth)acrylate, butoxyethyl(meth)acrylate, ethoxydiethyleneglycol(meth)acrylate, methoxytriethyleneglycol(meth)acrylate, methoxytripropyleneglycol(meth)acrylate, methoxypolyethyleneglycol(meth)acrylate, phenoxydiethyleneglycol(meth)acrylate, p-nonylphenoxypolyethyleneglycol(meth)acrylate, p-nonylphenoxypolypropyleneglycol(meth)acrylate, tetrafluoropropyl(meth)acrylate, 1,1,1,3,3,3-hexafluoroisopropyl(meth)acrylate, octafluoropentyl(meth)acrylate, heptadecafluorodecyl(meth)acrylate, tribromophenyl(meth)acrylate, methyl α-hydroxymethyl acrylate, ethyl α-hydroxymethyl acrylate, propyl α-hydroxymethyl acrylate, butyl α-hydroxymethyl acrylate, N-phenylmaleimide, N-(4-chlorophenyl)maleimide, methacrylic acid, maleic acid, and itaconic acid.

3. The ink composition as set forth in claim 1, wherein the weight average molecular weight of) the binder polymer is in the range of 1,000 to 50,000.

4. The ink composition as set forth in claim 1, wherein) the binder polymer is included in an amount in the range of 1 to 20 wt % on the basis of the total weight of the ink composition.

5. The ink composition as set forth in claim 1, wherein) the polymerizable compound that has the ethylenical unsaturation bond is one or more selected from the group consisting of ethyleneglycol diacrylate, triethyleneglycol diacrylate, 1,3-butanediol diacrylate, neopentylglycol diacrylate, 1,6-hexanediol diacrylate, trimethylol triacrylate, trimethylolpropane triacrylate, pentaerithrytol triacrylate, ditrimethylolpropane tetraacrylate, dipentaerthrytol tetraacrylate, dipentaerithrytol pentaacrylate, dipentaerithrytol hexaacrylate, and a(meth)acrylate monomer thereof.

6. The ink composition as set forth in claim 1, wherein) the polymerizable compound that has an ethylenical unsaturation bond is included in an amount in the range of 1 to 20 wt % on the basis of the total weight of the ink composition.

7. The ink composition as set forth in claim 1, wherein) the thermal initiator includes one or more selected from the group consisting of 2,2′-azobisisobutyronitrile (AIBN), 2,2′-azobis-(2,4-dimethylvaleronitrile), 2,2′-azobis-(4-methoxy-2,4-dimethylvaleronitrile), 2-cyano-2-propylazoformamide, 1,1′-azobis(cyclohexane-1-carbonitrile), 2,2′-azobis(2-methylbutyronitrile), V-40, VA-086, VA-085, VF096, Vam-110, and Vam-111 (manufactured by Wako pure chemicals ind.), benzoyl peroxide, lauroyl peroxide, t-butylperoxy pivalate and 1,1′-bis-(bis-t-butylperoxy)cyclohexane.

8. The ink composition as set forth in claim 1, wherein) the photo-initiator includes one or more selected from the group consisting of an acetophenone compound, a biimidazole compound, a triazine compound and an oxime compound.

9. The ink composition as set forth in claim 1, wherein) the thermal initiator or photo-initiator is included in an amount in the range of 0.1 to 5 wt % on the basis of the total weight of the ink composition.

10. The ink composition as set forth in claim 1, wherein) the solvent that has the boiling point of less than 180° C. is one or more selected from the group consisting of propylene glycol methyl ether acetate, ethylene glycol monomethyl ether acetate, ethylene glycol ethyl ether acetate, propylene glycol monobutyl ether acetate, ethyl isobutyl ether, ethyl ethoxy propionate, methoxy propanol, butoxy propanol, 2-butoxy ethanol, butyl acetate, 1-butoxy-2-propanol, cyclohexanone, dimethyl ketone, methyl butyl ketone and methyl hexyl ketone.

11. The ink composition as set forth in claim 1, wherein) the solvent that has the boiling point in the range of less than 180° C. is included in an amount in the range of 0.01 to 30 wt % on the basis of the total weight of the solvent.

12. The ink composition as set forth in claim 1, wherein) the solvent that has the hydroxyl group is one or more selected from the group consisting of ethanol, propanol, butanol, methoxy propanol, ethoxy propanol, butoxy propanol, i-propyl alcohol, benzyl alcohol, phenol, 2-propyl phenol, 2-isopropyl phenol, 2-sec-butyl phenol, 2-tert-butyl phenol, 2-phenylphenol, 2-cyclohexyl phenol, 2-nonylphenol, 2-naphthyl phenol, 4-propyl phenol, 4-cyclohexyl phenol, 4-naphthyl phenol, 4-dodecyl phenol, 4-octadecyl phenol, ethylene glycol monophenyl ether, ethylene glycol monohexyl ether, ethylene glycol 2-ethylhexyl ether, diethylene glycol monomethyl ether, diethylene glycol monoethyl ether, diethylene glycol monopropyl ether, diethylene glycol monobutyl ether, diethylene glycol monohexyl ether, triethylene glycol monomethyl ether, triethylene glycol monoethyl ether, triethylene glycol monobutyl ether, triethylene glycol monopropyl ether, dipropylene glycol monobutyl ether, tripropylene glycol monomethyl ether, and tripropylene glycol monobutyl ether.

13. The ink composition as set forth in claim 1, wherein) the solvent that has the hydroxyl group is included in an amount in the range of 5 to 50 wt % on the basis of the total weight of the solvent.

14. The ink composition as set forth in claim 1, wherein) the solvent that has the boiling point of 180° C. or more is one or more selected from the group consisting of ethylene glycol monobutyl ether acetate, diethylene glycol monobutyl ether acetate, diethylene glycol monoethyl ether acetate, dipropylene glycol monomethyl ether acetate, dipropylene glycol ethyl ether acetate, dipropylene glycol propyl ether acetate, and dipropylene glycol monobutyl ether acetate.

15. The ink composition as set forth in claim 1, wherein I) the solvent that has the boiling point of 180° C. or more is included in an amount in the range of 50 to 95 wt % on the basis of the total weight of the solvent.

16. The ink composition as set forth in claim 1, wherein the solvent that has components I), II), and III) is included in an amount in the range of 65 to 85 wt % on the basis of the total weight of the ink composition.

17. The ink composition as set forth in claim 1, wherein the ink composition further comprises one or more additives selected from a dispersing agent, a curing accelerating agent, a thermal polymerization inhibiting agent, a plasticizer, an adhesion accelerating agent, a filler, a defoaming agent, a dispersion assisting agent, an agglomeration preventing agent and a surfactant.

18. A method for manufacturing a color filter, the method comprising the steps of:
preparing a light blocking portion that is formed by the black matrix pattern and a pixel portion that is divided by the black matrix pattern;
filling the ink composition according to claim 1 in the pixel portion that is divided by the black matrix by using an inkjet method; and
curing the filled ink composition.

19. A color filter comprising:
a light blocking portion that is formed by a black matrix pattern; and
a pixel portion that is filled with an ink layer formed by using the ink composition according to claim 1.

20. A display device comprising the color filter of claim 19.
